(19) United States
(12) Patent Application Publication
(10) Pub. No.: US 2024/0408651 A1
(43) Pub. Date: Dec. 12, 2024

(54) AIR BLOW GUN

(71) Applicant: KOGANEI CORPORATION, Koganei-shi, Tokyo (JP)

(72) Inventors: Yuji TAKAHASHI, Tokyo (JP); Koji SHIODA, Tokyo (JP); Takehiro KEMUYAMA, Tokyo (JP)

(21) Appl. No.: 18/698,231

(22) PCT Filed: Aug. 17, 2022
(86) PCT No.: PCT/JP2022/031130

§ 371 Date: Apr. 3, 2024

(30) Foreign Application Priority Data
Oct. 5, 2021 (JP) 2021-163916

(51) Int. Cl. B08B 5/02

(52) U.S. Cl. CPC B08B 5/02

(57) ABSTRACT

The disclosure includes a body case 11 including a grip case portion 12 provided with an inclined connection surface 14 at a tip and held by an operator, and a tip case portion 13 capable of relative rotation with respect to the grip case part 12 and incorporating a discharge nozzle 21 for discharging air; a manual valve 31 switched between an open state of discharging the air to the discharge nozzle and a closed state of stopping the discharge; and a trigger lever 34 operating the manual valve 31 between the open state and the closed state, the tip case portion 13 is switched to either a straight position of straight extending with respect to the grip case portion 12 and an inclination position inclined with respect to the grip case portion 12.

### CROSS-REFERENCE TO RELATED APPLICATIONS

This application is a National Stage application of International Patent Application No. PCT/JP2022/031130, filed on Aug. 17, 2022, which claims priority to Japanese Patent Application No. 2021-163916, filed Oct. 5, 2021, each of which is hereby incorporated by reference in its entirety.

### TECHNICAL FIELD

The present invention relates to an air blow gun in which a discharge nozzle for discharging air toward an object can be used by switching to any of a straight state and a bent state with respect to a grip portion.

### BACKGROUND

An air blow gun is used to blow compressed air onto an object such as a workpiece or a coated surface to remove chips, dust, and the like from a surface of the object. The air blow gun has a grip portion that is gripped by an operator and a discharge nozzle provided at a tip of the grip portion. In an air blow gun disclosed in Patent Document 1, a discharge nozzle is provided at a tip portion of a grip portion so as to be inclined at a discharge angle of approximately 90 degrees with respect to the grip portion. This air blow gun is an intermittent air blow gun, that is, a pulse blow gun that intermittently discharges air toward the object.

Patent Document 1: Japanese Patent No. 6591686

### SUMMARY

In using the air blow gun to remove the dust or the like from the surface of the object, air is often blown onto the surface of the object with the discharge nozzle located at a right angle. For this reason, like the air blow gun disclosed in Patent Document 1, there are many forms of the air blow gun having the discharge nozzle that is at the right angle with respect to the grip portion.

There are cases in which: the surface of the object to which air is discharged is a bottom surface of a hole formed in a member; obstacles are arranged around the surface of the object; and the like, and further there is a case in which if the discharge nozzle is inclined with respect to the grip portion, spraying work cannot easily be performed.

An object of the present invention is to provide an air blow gun in which a working position of an discharge nozzle with respect to a grip portion can be switched among a plurality of positions.

An air blow gun of the present invention includes: a grip case portion provided with a first connection surface at a tip and gripped by an operator; a tip case portion provided at base end with a second connection surface relatively rotatable with respect to the first connection surface, incorporating a discharge nozzle for discharging air, and forming a body case together with the grip case portion; a manual valve provided in the grip case portion, and switched between an open state of discharging the air to the discharge nozzle and a closed state of stopping the discharge; and a trigger lever provided in the grip case portion, and operating the manual valve between the open state and the closed state, the first connection surface being inclined to a longitudinal axis line of the grip case portion, and the second connection surface being inclined to a longitudinal axis line of the tip case portion, and the tip case portion being switched to either a straight position extending with respect to the grip case portion and an inclination position inclined with respect to the grip case portion.

According to the object blowing air, the tip case portion provided with the discharge nozzle can be switched to any of the straight-extending straight position with respect to the grip case portion and the inclination position inclined with respect to the grip case portion, so that the blowing work of the air can be done with respect to the various objects by the single air blow gun.

### BRIEF DESCRIPTION OF THE DRAWINGS

FIG. 1 is a perspective view showing an air blow gun, which is one embodiment, in a state of straight extending a discharge nozzle with respect to a grip portion;

FIG. 2 is a perspective view showing the air blow gun in which the discharge nozzle is switched from a state shown in FIG. 1 to a state inclined with respect to the grip portion;

FIG. 3 is a partially cutaway side view showing an inside of the air blow gun in a state where a pulse blow unit is attached and the discharge nozzle is set straight with respect to the grip portion;

FIG. 4(A) is a partially cutaway side view showing the inside of the air blow gun in which the pulse blow unit is attached and the discharge nozzle is inclined with respect to the grip portion, and (B) is a front view showing a continuous blow unit removing the pulse blow unit and being capable of attaching the air blow gun;

FIG. 5 is a cross-sectional view taken along line 5-5 in FIG. 4(A);

FIG. 6 is an enlarged cross-sectional view of a portion 6 in FIG. 4, (A) showing a state in which a lock member is at a locked position, and (B) showing a state in which the lock member is at an unlocked position;

FIG. 7(A) is an exploded perspective view of a connection portion provided in a manual valve and a rotary joint attached to the connection portion, and (B) is a cross-sectional view showing an assembly state of the connection portion of the manual valve and the rotary joint;

FIG. 8(A) is an exploded perspective view of a connection portion provided in a nozzle holder and a rotary joint attached to the connection portion, and (B) is a cross-sectional view showing an assembly state of the connection portion provided in the nozzle holder and the rotary joint;

FIG. 9 is a side view showing an inside of the grip portion of the air blow gun to which the continuous blow unit is attached;

FIG. 10 is a pneumatic circuit diagram of the air blow gun, (A) showing a case where the pulse blow gun is attached to the air blow unit, and (B) showing a case where the continuous blow unit is attached to the air blow gun; and

FIG. 11 is a pneumatic circuit diagram showing an operation of the air blow gun when the pulse blow unit is attached, (A) showing a state in which air is not supplied to the air blow gun from outside, (B) showing an instant state in which air is supplied from outside, (C) showing a state in which the manual valve is operated and air is discharged from the nozzle, and (D) showing a state in which the discharge of air from the nozzle stops after a predetermined time has passed since the air is discharged from the nozzle.

### DETAILED DESCRIPTION

Hereinafter, embodiments of the present invention will be described in detail with reference to the drawings.

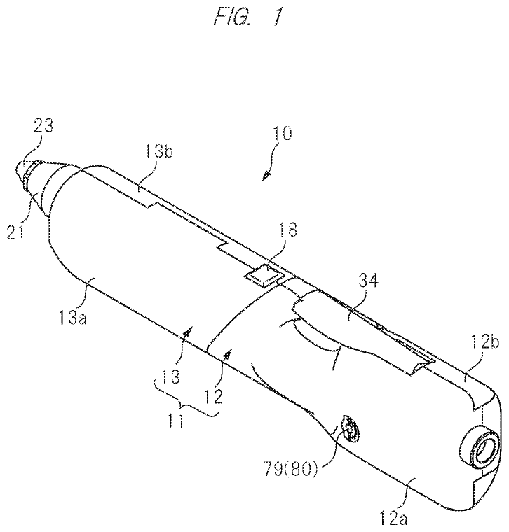

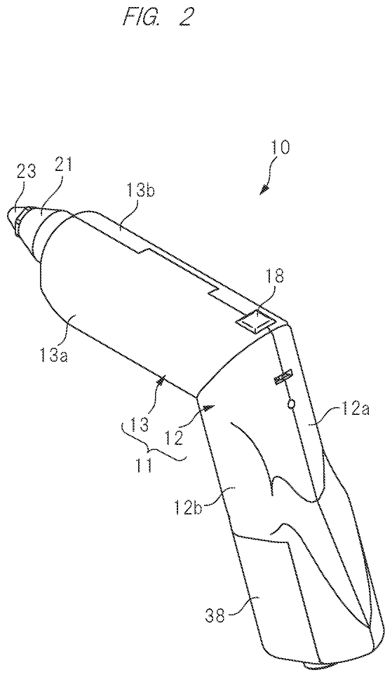

As shown in FIGS. 1 and 2, an air blow gun 10 has a body case 11 as a gun body, and the body case 11 includes a grip case portion 12 grasped by an operator, and a tip case portion 13 that is rotatably attached to the grip case portion. The grip case portion 12 is assembled by butting two case halves 12a, 12b, and the tip case portion 13 is assembled by butting two case halves 13a, 13b. Inside the body case 11 configured by the grip case portion 12 and the tip case portion 13, there is formed a space which accommodates a device(s) for configuring the air blow gun.

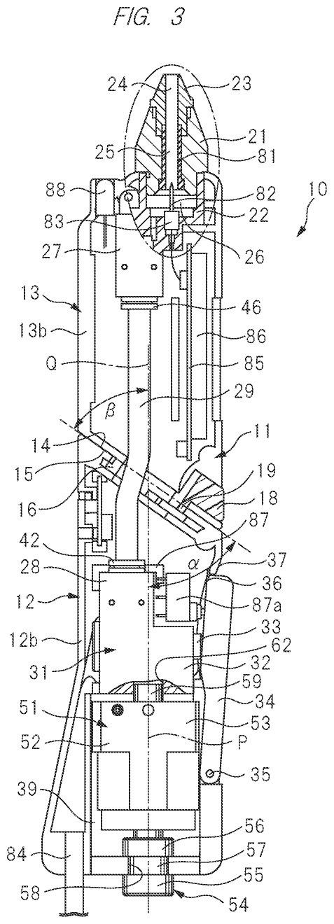

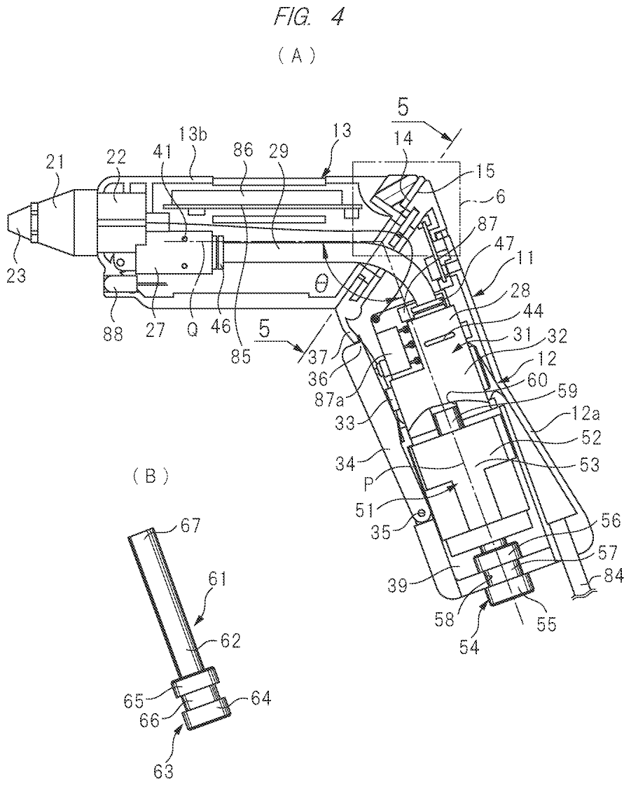

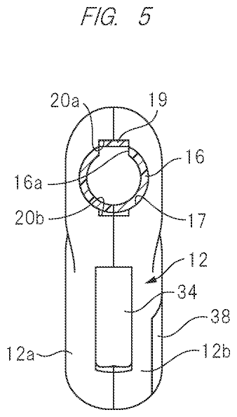

As shown in FIGS. 3 and 4(A), an inclined first connection surface 14 is provided at a tip of the grip case portion 12, and a first inclination angle α of the connection surface 14 with respect to a longitudinal axis line P of the grip case portion 12 is 55 degrees. A second connection surface 15 struck by the first connection surface 14 is provided at a base end of the tip case portion 13, and a second inclination angle β of the connection surface 15 with respect to a longitudinal axis line Q of the tip case portion 13 is also 55 degrees similarly. As shown in FIG. 5, an annular projection portion 16 is provided on the tip case portion 13, and protrudes from the connection surface 15. A circular fitting hole 17 into which the annular projection portion 16 is rotatably fitted is formed in the grip case portion 12. Note that the first inclination angle and the second inclination angle refer to angles, which is formed by the longitudinal axis lines P, Q and the connection surfaces 14, 15, being less than 90 degrees.

As shown in FIGS. 1 and 3, when the first inclination angle α and the second inclination angle β oppose each other, the tip case portion 13 becomes a straight position extending with respect to the grip case portion 12. In contrast, as shown in FIGS. 2 and 4(A), if the grip case portion 12 is rotated 180 degrees with respect to the tip case portion 13 and the first inclination angle α and the second inclination angle β becomes a state of being adjacent to each other, the tip case portion 13 becomes an inclination position inclined to the grip case portion 12. Even If the tip case portion 13 is rotated 180 degrees with respect to the grip case portion 12, the same inclination position is obtained. In this manner, when the tip case portion 13 is switched to the straight position by rotating one of the tip case portion 13 and the grip case portion 12 relative to the other, the body case 11 becomes an elongated straight shape. Meanwhile, when the tip case portion 13 is switched to the inclination position, the body case 11 becomes a bent shape like being bent.

A bending angle θ between the longitudinal axis line P of the grip case portion 12 and the longitudinal axis line Q of the tip case portion 13 in a bent state becomes 110 (α+β) degrees, which is equal to the sum of the inclination angle α and the inclination angle β. If the angles α, β are each set to 45 degrees, the bending angle θ becomes 90 degrees. By changing the inclination angles of the connection surfaces 14, 15 in this way, the bending angle θ of the body case 11 can be set to various angles. When the inclination angle α and the inclination angle β are equal, the bending angle in the straight shape becomes 180 degrees and the longitudinal axis line Q of the tip case portion 13 and the longitudinal axis line P of the grip case portion 12 become a straight-extending state in a coaxial or parallel state. Note that the inclination angles α, β may be different angles, and the bending angle θ in the straight shape may be an angle other than 180 degrees.

As shown in FIGS. 2 and 3, a lock button, that is, a lock member 18 is provided at the base portion of the tip case portion 13, and a radially outer end of the lock member 18 is exposed to an outside of the tip case portion 13. A lock piece 19 is provided at a radially inner end of the lock member 18, and the lock piece 19 crosses the connection surface 14 of the grip case portion 12 and protrudes into the grip case portion. As shown in FIG. 5, a first lock groove 20a and a second lock groove 20b are formed in the grip case portion 12 so as to be shifted by 180 degrees in a rotation direction of the tip case portion 13.

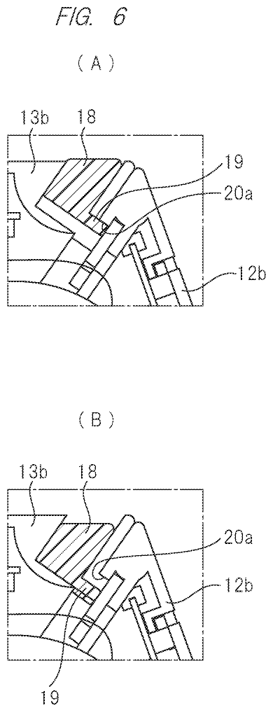

A spring force (not shown) is applied in a direction of protruding the lock member 18 outward from the tip case portion 13. If the lock member 18 is pushed inward from the tip case portion 13 against the spring force, the lock piece 19 enters a notch portion 16a formed in the annular projection portion 16 and the rotation of the tip case portion 13 with respect to the grip case portion 12 is permitted. As shown in FIGS. 4(A) and 5, when the tip case portion 13 becomes an inclined position with respect to the grip case portion 12, the lock piece 19 enters the lock groove 20a and relative rotation of the tip case portion 13 with respect to the grip case portion 12 is restricted. Consequently, the body case 11 retains its bent shape. FIG. 6(A) shows a lock state in which the lock piece 19 has entered the lock groove 20a. As shown in FIG. 6(B), when the lock member 18 is pushed into and the lock piece 19 is retracted from the lock groove 20a, the lock is released and the tip case portion 13 becomes rotatable relative to the grip case portion 12.

When the tip case portion 13 is rotated from the inclined position to the straight position by 180 degrees relative to the grip case portion 12 in a state in which the lock by the lock piece 19 is released, the lock piece 19 enters into the lock groove 20b and the relative rotation of the tip case portion 13 relative to the grip case portion 12 is restricted. Consequently, the body case 11 maintains a straight-extending straight shape. When the lock member 18 is pushed into under a locked state in which the lock piece 19 has entered the lock groove 20b, the lock is released and the tip case portion 13 can be relatively rotated from the straight position toward the inclined position.

Although the lock member 18 is provided on the tip case portion 13, the lock member 18 may be provided on the grip case portion 12.

A discharge nozzle 21 made of a conductive material is provided so as to protrude from a tip surface of the tip case portion 13 of the body case 11. As shown in FIG. 3, the discharge nozzle 21 is attached to a nozzle holder 22 made of an insulating material and provided in the tip case portion 13. An air discharge port 23 made of a conductive material is attached to the discharge nozzle 21, and a discharge hole 24 formed in the air discharge port 23 communicates with a discharge channel 25 formed in the discharge nozzle 21, and the discharge channel 25 communicates with a communication channel 26 formed in the nozzle holder 22. A nozzle-side connection portion 27 is provided in the nozzle holder 22, and a guide hole communicating with the communication chamber 26 is provided inside the nozzle-side connection portion 27.

A manual valve 31 is incorporated inside the grip case portion 12. A valve-side connection portion 28 is provided to the manual valve 31, and a guide tube 29 is provided between the connection portion 28 and the connection portion 27 to guide air flowing out of the manual valve 31 to the discharge nozzle 21. The manual valve 31 is a two-port two-position directional control valve and has a valve housing 32 in which the connection portion 28 is provided. A main valve is incorporated in the valve housing 32 so as to reciprocate in an axial direction, and a manual operation end portion 33 of the main valve protrudes on a back surface side of the grip case portion 12. A trigger lever 34 is provided on a back surface of the grip case portion 12, and a lower end portion of the trigger lever 34 is rotatably supported on the grip case portion 12 by a support pin 35. An engagement piece 36 is provided at an upper end portion of the trigger lever 34, and the engagement piece 36 is engaged with a stopper 37 of the grip case portion 12.

If it is assumed that a surface on which the trigger lever 34 is provided is the back surface of the grip case portion 12, the manual operation end portion 33 contacts with the back surface of the trigger lever 34. A spring member incorporated in the valve housing 32 applies a spring force to the main valve of the manual valve 31 in a direction toward the trigger lever 34. Consequently, a pressing force is applied to the trigger lever 34 in a direction in which the engagement piece 36 is engaged with the stopper 37. When the engagement piece 36 is engaged with the stopper 37 of the grip case portion 12, the manual valve 31 is in a closed state, that is, in an OFF state and when the trigger lever 34 is push-operated by the operator, the main valve is driven and the manual valve 31 is switched to an open state, that is, to an ON state. When the manual valve 31 is switched to the ON state, compressed air flows out from an output port of the manual valve 31. Consequently, an internal flow path of the guide tube 29 provided between the connection portion 28 integral with the valve housing 32 and the connection portion 27 integral with the nozzle holder 22 allows the compressed air to flow out through the communication chamber 26 of the nozzle holder 22 to a discharge flow path 25.

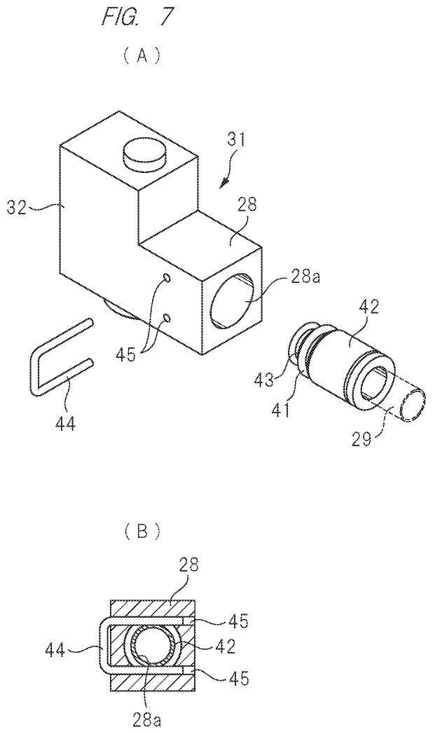

FIG. 7(A) is an exploded perspective view of the connection portion 28 provided in the valve housing 32 of the manual valve 31 and a rotary joint 42 attached to the connection portion 28, and FIG. 7(B) is a cross-sectional view showing an assembly state of the connection portion 28 and the rotary joint 42.

The cylindrical rotary joint 42 is rotatably attached to an attachment hole 28a formed in the connection portion 28, and one end of the guide tube 29 is attached to the rotary joint 42. An annular groove 43 is formed in an outer peripheral portion of the rotary joint 42, and a U-shaped stopper pin 44 that is engaged with the annular groove 43 is inserted into an attachment hole 45 formed in the connection portion 28. The engagement of the stopper pin 44 with the annular groove 43 prevents the rotary joint 42 from coming off the attachment hole 28a, and the rotary joint 42 can rotate in a state of contacting with the stopper pin 44. When the guide tube 29 receives a twist force, the rotary joint 42 rotates together with the guide tube 29, so that twist occurrence of the guide tube 29 is suppressed and the guide tube 29 maintains the straight extending state. A sealing member 41 seals between the rotary joint 42 and the attachment hole 28a.

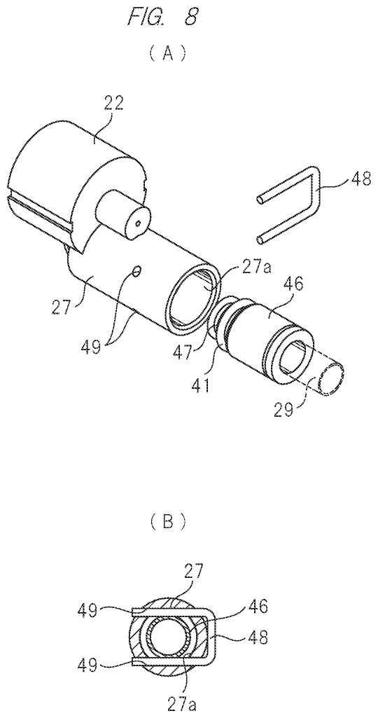

FIG. 8(A) is an exploded perspective view of the connection portion 27 provided in the nozzle holder 22 and the rotary joint 46 attached to the connection portion 27, and FIG. 8(B) shows a cross-sectional view showing an assembly state of the connection portion 27 and the rotary joint 46.

The cylindrical rotary joint 46 is rotatably attached in an attachment hole 27a formed in the connection portion 27, and the other end portion of a guide tube 29 is attached to the rotary joint 46. An annular groove 47 is formed in an outer peripheral portion of the rotary joint 46, and a U-shaped stopper pin 48 engaged with the annular groove 47 is inserted into an attachment hole 49 formed in the connection portion 27. The engagement of the stopper pin 48 with the annular groove 47 prevents the rotary joint 46 from coming off the attachment hole 27a, so that the rotary joint 46 is rotatable while contacting with the stopper pin 48. When the guide tube 29 receives the twist force, the rotary joint 46 rotates together with the guide tube 29, so that twist occurrence of the guide tube 29 is suppressed. A sealing member 41 seals a region between the rotary joint 46 and the attachment hole 27a.

When the rotary joints 42, 46 are attached to both end portions of the guide tube 29 in this manner and when one of the tip case portion 13 and the grip case portion 12 is rotated relative to the other, the guide tube 29 receives the twist force. However, the rotary joints 42, 46 rotates together with the guide tube 29, so that the guide tube 29 maintains a straight extending state without being twisted. Consequently, an air flow path of the guide tube 29 is not narrowed, and the air discharged from the manual valve 31 smoothly flows out without increasing flow resistance. Although the rotary joints 42, 46 are provided on both connection portions 27, 28, the twist occurrence of the guide tube 29 can be suppressed even if the rotary joint is provided on only one of them. However, if the rotary joints 42, 46 are provided to both the connection portions 27, 28, effect of suppressing the twist occurrence can be further enhanced. Further, by attaching the rotary joints 42, 46 to the attachment holes 27a, 28a provided in the connection portions 27, 28, a volume when the rotary joints 42, 46 are attached to the connection portions 27, 28 can be reduced, so that the air blow gun 10 can be made small.

As shown in FIG. 2, a unit exchange lid 38 is positioned on a right side surface side of the grip case portion 12 and provided on a case half 12b. When the unit exchange lid 38 for opening and closing a unit accommodation chamber 39 is removed from the grip case portion 12, as shown in FIGS. 3 and 4(A), the unit accommodation chamber 39 formed in the grip case portion 12 is exposed to the outside. The unit exchange lid 38 is fixedly attached to the case half 12b by screw members and engagement claws (not shown).

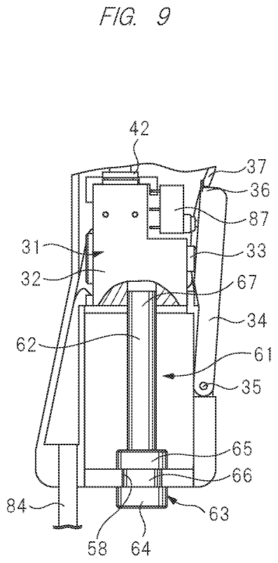

Any of the pulse blow unit 51 shown in FIGS. 3 and 4(A) and the continuous blow unit 61 shown in FIGS. 4(B) and 9 can be selectively arranged in the unit accommodation chamber 39. FIG. 4(B) is a front view showing a state in which the continuous blow unit 61 is removed from the unit accommodation chamber 39.

The pulse blow unit 51, as shown in FIGS. 3 and 4(A), has a switching valve 52 for converting compressed air, which is supplied from outside, into pulse-like intermittent air. The switching valve 52 is a two-port two-position directional control valve, and has a main valve incorporated in the valve housing 53 so as to be reciprocable in an axial direction. A small-diameter piston is provided on one end portion of the main valve, and a large-diameter piston is provided on the other end portion. A small-diameter pilot chamber in which the small-diameter piston is incorporated and a large-diameter pilot chamber in which the large-diameter piston is incorporated are formed in the valve housing 53.

The valve housing 53 is provided with an intermittent input end portion 54 through which compressed air is supplied to the switching valve 52 from outside, and a flow path in the intermittent input end portion 54 communicates with an input port of the switching valve 52. The intermittent input end portion 54 has an input joint 55, and an air supply member (not shown) made of a tube or the like is detachably attached to the input joint 55. The air supply member guides the compressed air from a supply source of the compressed air to the intermittent input end 54. The intermittent input end portion 54 has a large-diameter flange portion 56, and a small-diameter portion 57 between the input joint 55 and the large-diameter flange portion 56 is detachably attached to the engagement hole 58 formed in the grip case portion 12 and serving as an input end attachment portion.

An intermittent output end portion 59 is provided in the valve housing 53, and a flow path in the intermittent output end portion 59 communicates with an output port of the switching valve 52. A projection portion of the intermittent output end portion 59 is detachably attached in a fitting hole 60 formed in the valve housing 32 of the manual valve 31 and serving as an attachment portion.

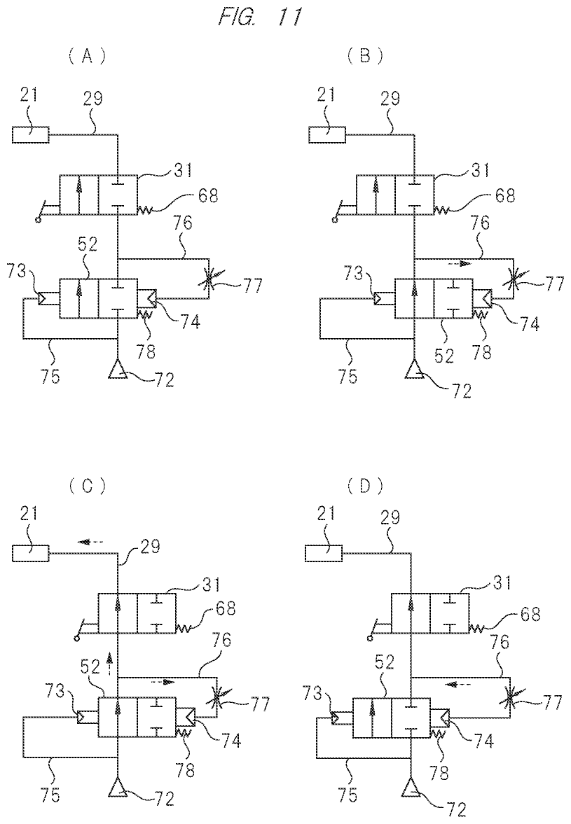

As will be described later with reference to FIG. 11, the switching valve 52 of the pulse blow unit 51 converts air, which is supplied to the intermittent input end portion 54 from outside, into intermittently pulsed air and outputs it to the intermittent output end portion 59.

The engagement hole 58 is formed by a semicircular hole formed in a lower end portion of the case half 12a and a semicircular hole (not shown) formed in a lower end portion of the unit exchange cover 38. When the unit exchange lid 38 is removed from the grip case portion 12, the pulse blow unit 51 can be taken out from the unit accommodation chamber 39 inside the grip case portion 12. At that time, the intermittent output end portion 59 is removed from the fitting hole 60. By providing the sealing member in the fitting hole 60, the gap between the intermittent output end portion 59 and the fitting hole 60 can be sealed.

As shown in FIGS. 4(B) and 9, the continuous blow unit 61 has a tube member 62 provided with a flow path inside, and a continuous input end portion 63 to which compressed air is supplied from the outside is provided at a lower end portion of the tube member 62. The continuous input end portion 63 has an input joint 64, and the air supply member (not shown) such as a tube is detachably attached to the input joint 64. The continuous input end portion 63 has a large-diameter flange portion 65, and a small-diameter portion 66 between the input joint 64 and the large-diameter flange portion 65 is detachably attached to the engagement hole 58 formed in the grip case portion 12 and serving as an input end attachment portion.

An upper end portion of the tube member 62 configures a continuous output end portion 67, and the continuous output end portion 67 is detachably attached to the fitting hole 60 formed in the valve housing 32 of the manual valve 31 and serving as an attachment portion. An outer diameter of the small-diameter portion 66 of the continuous blow unit 61 is substantially the same as an outer diameter of the small-diameter portion 57 of the pulse blow unit 51. Further, an outer diameter of the continuous output end portion 67 of the continuous blow unit 61 is substantially the same as an outer diameter of the intermittent output end portion 59 of the pulse blow unit 51. Furthermore, a length between the large-diameter flange portion 65 of the continuous blow unit 61 and a tip of the continuous output end portion 67 is substantially the same as a length between the large-diameter flange portion 56 of the pulse blow unit 51 and the tip of the intermittent output end portion 59.

Accordingly, both the intermittent input end portion 54 and the continuous input end portion 63 can be engaged with the engagement hole 58, and both the intermittent output end portion 59 and the continuous output end portion 67 can be fitted into the engagement hole 60 of the manual valve 31. Therefore, both the pulse blow unit 51 and the continuous blow unit 61 can be selectively arranged in the unit accommodation chamber 39 of the grip case portion 12. This makes it possible for the air blow gun 10 to function as both a pulse blow gun and a continuous blow gun.

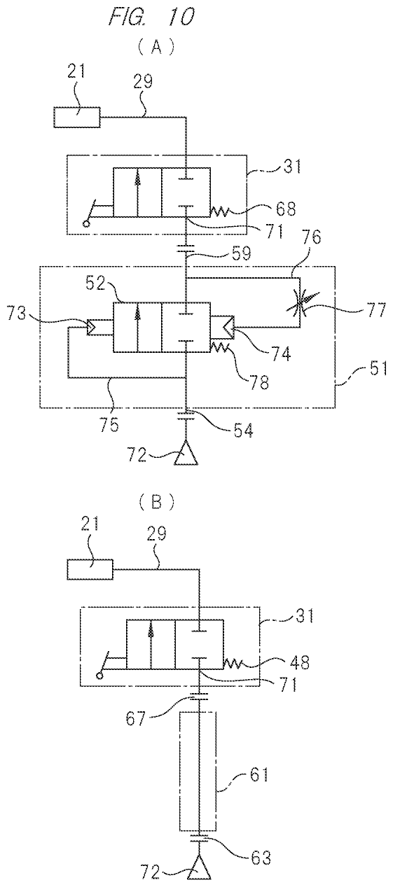

FIG. 10(A) is a pneumatic circuit diagram of the air blow gun 10 when the pulse blow unit 51 is attached to the air blow gun 10, and FIG. 10(B) is a pneumatic circuit diagram of the air blow gun 10 when the continuous blow unit 61 is attached to the air blow gun 10.

As shown in FIG. 10, the manual valve 31 is a two-port two-position directional control valve. When the manual valve 31 is operated by the trigger lever 34, the input port of the manual valve 31 and a flow path of an outflow pipe are communicated with each other and the manual valve 31 becomes an ON-state. Consequently, the compressed air that has passed via the manual valve 31 is discharged from the discharge nozzle 21. Meanwhile, when the trigger lever 34 is returned by the spring force of the spring member 68, the manual valve 31 becomes an OFF state and the communication between the input port of the manual valve 31 and an internal flow path of the guide tube 29 is blocked.

When the pulse blow unit 51 is attached in the unit accommodation chamber 39, the intermittent output end portion 59 communicates with the input port 71 of the manual valve 31 and the intermittent input end portion 54 communicates with an air supply member connected to an air supply source 72 and made of a tube or like. As shown in FIG. 10(A), the pulse blow unit 51 has a switching valve 52 which is a two-port two-position directional control valve, a small-diameter piston provided at one end portion of the main valve is incorporated into a small-diameter pilot chamber 73, and a large-diameter piston provided at the other end of the main valve is incorporated in a large-diameter pilot chamber 74.

The small-diameter pilot chamber 73 communicates with the flow path of the intermittent input end portion 54 via the pilot flow path 75, and the large-diameter pilot chamber 74 communicates with the flow path of the intermittent output end portion 59 via the pilot flow path 76. A flow rate of air flowing through the pilot flow path 76 is adjusted by a variable throttle valve 77. A spring force in a direction of blocking the communication between the input port and the output portion is applied to main valve by the spring member 78. An operation knob 79 of the throttle valve 77 is provided in the pulse blow unit 51 and, as shown in FIG. 1, a through-hole 80 for operating the operation knob 79 from the outside is provided in the grip case portion 12. The operation knob 79 is arranged deep inside the through-hole 80. The through-hole 80 may be provided in the grip case portion 12, may be provided in the case halves 12a and 12b, or may be provided in the unit exchange lid 38. Also, when used as the continuous blow gun, the through-hole 80 may be closed with a seal or plug.

Meanwhile, when the continuous blow unit 61 is attached to the unit accommodation chamber 39, as shown in FIG. 10(B), the continuous output end portion 67 communicates with the input port 71 of the manual valve 31 and the continuous input end portion 63 communicates with the air supply member connected to the air supply source 72. Consequently, the compressed air from the air supply source 72 is directly supplied to the input port 71 of the manual valve 31.

FIG. 11 is a pneumatic circuit showing an operation of the air blow gun 10 when the pulse blow unit 51 is attached to the unit accommodation chamber 39. As shown in FIG. 11(A) shows a state in which no air is supplied from the air supply source 72 and, at this time, the manual valve 31 and the switching valve 52 of the pulse blow unit 51 are an OFF-state. When air is not supplied from the air supply source 72, both become the OFF-state. FIG. 11(B) shows a state immediately after air is supplied from the air supply source 72 to the input port of the switching valve 52, and the switching valve 52 becomes the ON-state, in which the input port and the output port communicate with each other, by the air supplied to the small-diameter pilot chamber 73 via the pilot channel 75.

Consequently, air is supplied to the large-diameter pilot chamber 74 via the pilot flow path 76. The compressed air from the air supply source 72 is supplied to the small-diameter pilot chamber 73 and the large-diameter pilot chamber 74, but the switching valve 52 is switched to the OFF-state by the air supplied to the large-diameter pilot chamber 74, whose area is large, and by the spring force. The switched time is set by adjusting the variable throttle valve 77. In this manner, even if air is supplied to the input port of the switching valve 52, the switching valve 52 remains the OFF-state unless the manual valve 31 is operated to the ON-state.

As shown in FIG. 11(C), when the manual valve 31 is switched to the ON-state, air is discharged from the discharge nozzle 21 via the switching valve 52 and the manual valve 31. The compressed air that has passed through the switching valve 52 branches into a flow that passes through the manual valve 31 and a flow that flows into the large-diameter pilot chamber 74. A thrust is applied to the main valve 52 in a direction of making the switching valve 52 an OFF-state via the air supplied to the large-diameter pilot chamber 74 by air flowing into the large-diameter pilot chamber 74. A thrust is applied to the main valve in a direction of making the switching valve 52 an ON-state via air supplied to the small-diameter pilot chamber 73 by air flowing into the small-diameter pilot chamber 73. When the thrust in the direction of making the switching valve 52 the ON-state by a pressure of the large-diameter pilot chamber 74 is increased, as shown in FIG. 11(D), the switching valve 52 is switched to the OFF-state. Consequently, the discharge of the air from the discharge nozzle 21 is stopped.

As shown in FIG. 11(D), when the switching valve 52 is switched to the OFF-state, the air in the large-diameter pilot chamber 74 is discharged toward the discharge nozzle 21. A discharge speed is adjusted by the throttle valve 77. When the pressure in the large-diameter pilot chamber 74 decreases, as shown in FIG. 11(C), the switching valve 52 is switched to the ON-state. In this manner, the switching valve 52 repeats the ON-state and the OFF-state, thereby generating a pulse blow(s) and discharging it from the discharge nozzle 21.

As shown in FIG. 3, a tube 81 made of an insulating material is incorporated in the discharge nozzle 21, and the discharge flow path 25 is formed inside the discharge nozzle 21 by the tube 81. A discharge electrode 82 configured by a discharge needle is attached to the nozzle holder 22 made of an insulating material. The discharge electrode 82 has a pedestal 83 fixed to the nozzle holder 22, and a tip portion protrudes into the discharge flow path 25. The discharge nozzle 21 configures a counter electrode, and when corona discharge is generated between the discharge nozzle 21 as the counter electrode and the discharge electrode 82, the compressed air flowing through the discharge path flow 25 is ionized.

A wire cable 84 is attached to the grip case portion 12 of the body case 11, a transformer substrate 85 is provided inside the tip case portion 13, and a switch substrate 87 is provided inside the grip case portion 12. The wire cable 84 is connected to the switch substrate 87, and the switch substrate 87 is connected to the transformer substrate 85. A high AC voltage from a power supply unit 86 provided on the transformer substrate 85 is applied between the counter electrode configured by the discharge nozzle 21 and the discharge electrode 82. Consequently, the corona discharge is generated around the sharp tip portion of the discharge electrode. When a positive high voltage is applied to the discharge electrode 82, the discharge electrode absorbs electrons in the nearby air, so that the nearby air becomes ions having a positive charge. In contrast, when a negative high voltage is applied to the discharge electrode 82, electrons are emitted from the discharge electrode, so that the nearby air becomes ions having a negative charge. When ionized air is blown onto a charged member such as an electronic component, the charge is neutralized and adhesion of foreign matters to the member is prevented.

An electric switch 87a is provided inside the grip case portion 12. The electric switch 87a contacts with a back surface of the trigger lever 34, and when the operator pushes the trigger lever 34, the electric switch 87a is turned on and the compressed air flowing through the discharge path flow 25 is ionized.

A lighting fixture 88 made of an LED is provided on the tip case portion 13, and the lighting fixture 88 can illuminate a discharge destination of air.

In the air blow gun 10 described above, as shown in FIG. 1, when the tip case portion 13 provided with the discharge nozzle 21 is straight extended with respect to the grip case portion 12, the body case 11 becomes a straight shape. The straight-shaped air blow gun 10 is suitable for, for example, a case of blowing air to a bottom surface of a hole. At this time, as shown in FIG. 1, the trigger lever 34, the lock member 18, and the body case 11 become a state of being arranged adjacent and side by side on the same surface. Meanwhile, as shown in FIG. 2, when the tip case portion 13 is rotated 180 degrees with respect to the grip case portion 12, the body case 11 becomes a bent shape, and this is suitable for the case where the operator blows air in a state of facing the object. At this time, the trigger lever 34 is shifted by 180 degrees with respect to the lock member 18. In this way, the air blow gun 10 can also be used in the straight shape as well as in the bent shape, and the shape of the body case 11 can be switched according to the object to be air-blown.

Further, when the pulse blow unit 51 is arranged in the unit accommodation chamber 39 of the body case 11, air can be intermittently blown to the object. Meanwhile, if the continuous blow unit 61 is arranged in the unit accommodation chamber 39 in place of the pulse blow unit 51, air can be continuously blown onto the object. In this way, one air blow gun 10 can be applied as both a pulse blow gun and a continuous blow gun.

Furthermore, when the object is a charged member, it is possible to ionize the air and blow it onto the object, which makes it possible to prevent foreign matters from adhering to the object due to static electricity. Meanwhile, if the object is not charged, non-ionized air can be blown onto the object. Making the air blow gun 10 a form of blowing the non-ionized air can use an air blow gun having a form of not providing the insulating tube 81, the discharge electrode 82, and the like.

The present invention is not limited to the above-described embodiments, and various modifications can be made without departing from the gist of the present invention. For example, portions of the rotary joints 42,46 may be rotatable together with the guide tube 29 with respect to the connection portions 27,28.

The air blow gun of the present invention is used to blow compressed air onto an object such as a workpiece or a coated surface to remove chips, dust, and the like from the surface of the object.

While the present disclosure has been illustrated and described with respect to the particular embodiment thereof, it should be appreciated by those of ordinary skill in the art that various modifications to this disclosure mat be made without departing from the spirit and scope of the present disclosure.

1. An air blow gun comprising:
a grip case portion provided with a first connection surface at a tip and gripped by an operator;
a tip case portion provided at base end with a second connection surface relatively rotatable with respect to the first connection surface, incorporating a discharge nozzle for discharging air, and forming a body case together with the grip case portion;
a manual valve provided in the grip case portion, and switched between an open state of discharging the air to the discharge nozzle and a closed state of stopping the discharge; and
a trigger lever provided in the grip case portion, and operating the manual valve between the open state and the closed state,
wherein the first connection surface is inclined to a longitudinal axis line of the grip case portion, and the second connection surface is inclined to a longitudinal axis line of the tip case portion, and
the tip case portion is switched to either a straight position extending with respect to the grip case portion and an inclination position inclined with respect to the grip case portion.

2. The air blow gun according to claim 1, further comprising a guide tube arranged across the tip of the grip case portion and the base end of the tip case portion and communicating with a communication chamber formed in a nozzle holder, which supports the discharge nozzle, and an output port of the manual valve,
wherein at least one of a connection portion between the guide tube and the output port and a connection portion between the guide tube and the communication chamber is provided with a rotary joint rotatable to the connection portion together with guide tube.

3. The air blow gun according to claim 1, further comprising a lock member restricting the rotation with respect to the grip case portion of the tip case portion when the tip case portion is switched to the straight position and when the tip case portion is switched to the inclined position.

4. The air blow gun according to claim 1,
wherein a unit accommodation chamber for selectively accommodating a pulse blow unit and a continuous blow unit is formed in the grip case portion, the pulse blow unit intermittently outputting, from an intermittent output end portion to the manual valve, the air supplied to an intermittent input end portion from outside, the continuous blow unit continuously outputting, from a continuous output end portion to the manual valve, the air supplied from a continuous output end portion to the manual valve, and
both of the continuous blow gun that continuously discharges the air toward the object and the pulse blow gun that discharges it intermittently can be applied.

5. The air blow gun according to claim 4,
wherein the manual valve has an attachment portion selectively attached to either the intermittent output end portion and the continuous output end portion, and the grip case portion having an input end attachment portion selectively attached to either the intermittent input end portion and the continuation input end portion.

6. The air blow gun according to claim 2,
wherein the nozzle holder is provided in the tip case portion,
a communication chamber is formed in the nozzle holder, the communication chamber guiding the air flowing out of the manual valve to a discharge flow path provided in the discharge nozzle, and
a discharge electrode for ionizing the air flowing through the discharge flow path is provided in the nozzle holder by generating corona discharge between a counter electrode and the discharge electrode, the discharge nozzle being regarded as the counter electrode.

7. The air blow gun according to claim 1,
wherein a first inclination angle of the first connection surface with respect to the longitudinal axis line of the grip case portion is equal to a second inclination angle of the second connection surface with respect to the longitudinal axis line of the tip case portion, and
at the straight position, the longitudinal axis line of the tip case portion is parallel to the longitudinal axis line of the grip case portion.
